(19) United States
(12) Patent Application Publication
(10) Pub. No.: US 2003/0042103 A1
(43) Pub. Date: Mar. 6, 2003

(54) Friction clutch with automatic wear compensation

(75) Inventors: Daniel V. Gochenour, Auburn, IN (US); Martin E. Kummer, Auburn, IN (US); Troy Reinoehl, Ashley, IN (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation

(21) Appl. No.: 09/943,543

(22) Filed: Aug. 30, 2001

(51) Int. Cl. F16D 13/75

(52) U.S. Cl. 192/70.25; 192/111 A; 192/105 C

(57) ABSTRACT

A friction clutch having a wear compensation device is provided that includes a cover assembly that is secured to a flywheel of an internal combustion engine for rotation therewith. A pressure plate is arranged in the cover assembly and is urged by a spring member toward the flywheel. At least one friction plate is arranged between the pressure plate and the flywheel enabling the pressure plate to provide a clamping force to press the friction plate against the flywheel. The wear compensation device includes two cooperating annular members that are changeable along their axial dimension to compensate for the increased distance between the pressure plate and the friction plate due to wear in the clutch.

### FIELD OF THE INVENTION

The present invention relates generally to a vehicular master friction clutch and, in particular, to a centrifugal master friction clutch with automatic wear compensation.

### BACKGROUND OF THE INVENTION

Vehicle drive-train systems that comprise an internal combustion engine, a master friction clutch and a transmission are well known in the art. Common state of the art vehicle master friction clutch installations generally comprise a pressure plate, a reaction plate and a diaphragm spring, all coupled for rotation together with an engine flywheel. More precisely, a typical master friction clutch also includes at least one clutch friction plate (commonly known as a driven disc) having at its outer periphery friction pads and at its inner periphery a hub that is mounted on a transmission input shaft.

When the clutch is disengaged, the pressure plate is axially removed from the friction plate and no torque is transferred between the engine flywheel and the friction plate. When the clutch is engaged, engine torque is transmitted from the flywheel to the hub of the clutch friction plate(s) via the friction pads, which are gripped between the pressure plate and flywheel under the action of the diaphragm spring. Over time, the clutch friction pads become progressively worn, which modifies little by little the axial positions of the various components of the clutch. Wear occurs not only in the friction pads, but also, to a lesser extent, in the pressure plate and flywheel. During the working life of the clutch, this wear causes a larger displacement of the pressure plate, diaphragm spring and reaction plate toward the engine to provide a clamping force on the friction plate(s). It is therefore desirable to compensate for the above mentioned wear effects, in order that the pressure plate, diaphragm spring and reaction plate will have a substantially constant configuration when the clutch is engaged.

Normally open (disengaged) vehicular master friction clutch systems, such as centrifugally operated friction clutches, are well known in the art. Centrifugally operated friction clutches typically include an input member driven by an internal combustion engine and weights rotatable with the input member which, upon rotation of the driving member, move radially outward under the effect of centrifugal force to cause the input member to frictionally engage an output member. An example of a centrifugally operated friction clutch may be seen by reference to pending U.S. patent application Ser. Nos. 09/813,494; 09/813,919; and 09/814,494, filed Mar. 21, 2001, which are owned by the assignee of the present invention and are hereby incorporated by reference in their entirety.

Common state of the art vehicular master friction clutch installations are normally closed (engaged) systems. Normally closed systems typically include a release member, such as a bearing mechanism, that selectively disengages the clutch under direction of the vehicle operator. Normally closed clutch systems typically employ an automatic wear compensation device to compensate for wear in the clutch friction plates, pressure plate and flywheel. However, conventional automatic wear compensation devices are designed specifically for use in normally closed (engaged) clutch systems, preventing their application in normally open (disengaged) clutch systems.

### SUMMARY OF THE INVENTION

In accordance with an embodiment of the present invention, a normally open, centrifugal master friction clutch is provided that includes a device that automatically compensates for wear in the frictional components of the clutch. In a preferred embodiment, the master friction clutch includes an input portion fixed for rotation with an engine flywheel and an output portion fixed for rotation with a transmission input shaft. The output portion comprises at least one friction plate having a hub portion that is secured to the transmission input shaft for rotation therewith. The input portion includes a cover assembly fixed to the engine flywheel via a mounting bracket and a wear compensation device disposed substantially between the cover assembly and the mounting bracket. The cover assembly comprises a pressure plate for applying a clamping force against the friction plate.

In a preferred embodiment, the wear compensation device comprises first and second annular members that cooperatively exhibit an axial length that changes according to a displacement characteristic of the pressure plate in relation to the friction plate as the friction plate wears from an initially installed condition to a worn condition. The first annular member includes a first side disposed adjacent the second annular member having a plurality of inclined cam portions, and a second side disposed opposite the first side. The second annular member includes a first side adjacent the mounting bracket and a second side that includes a plurality of inclined cam portions configured to engage the cam portions of the first member. The cam portions on the first and second annular members cooperate to vary the axial length of the mating annular members upon rotation of the first annular member relative to the second annular member. The increased length of the cooperating annular members modifies the position of the cover assembly relative to the friction plate to compensate for the increased distance between pressure plate and the friction plate due to wear in the frictional components of the clutch.

The wear compensation device further includes a resilient member disposed between the first annular member and the second annular member. The spring force of the resilient member causes the first annular member to rotate relative to said second annular member in the absence of an axial force acting against the first annular member. The wear compensation device also includes an adjustment member that is configured to engage the first annular member to limit the degree of rotation of the first annular member relative to the second annular member.

Among other advantages, the inventive wear compensation device is suited for use in a normally open, centrifugal master friction clutch. Another advantage is that the inventive wear compensation device reduces the possibility of over-adjusting or under-adjusting a normally open, centrifugal vehicular master friction clutch.

Various additional aspects and advantages of this invention will become apparent to those skilled in the art from the following detailed description of the preferred embodiment, when read in light of the accompanying drawings.

### BRIEF DESCRIPTION OF THE DRAWINGS

The features and inventive aspects of the present invention will become more apparent upon reading the following detailed description, claims, and drawings, of which the following is a brief description:

FIG. 1 is a schematic illustration of a vehicular drive-train system utilizing the centrifugal clutch of the present invention.

FIG. 2 is a schematic illustration, in graphical format, of the clamping force characteristics of the centrifugal clutch of the present invention at various engine speeds.

FIG. 3 is a partial cross-sectional view of the cover assembly, centrifugal mechanism and wear compensation device of the present invention.

FIG. 4 is a partial sectional view of a roller, ramp, and clamp force limiting spring member adjacent the centrifugal components of the clutch.

FIG. 5A and 5B are partial sectional views illustrating the position of the flyweights in the disengaged position and the engaged position, respectively.

FIG. 6 is a schematic partial sectional view of the clutch of the present invention.

FIG. 7 is a partial cross-sectional view of the clutch of the present invention.

FIG. 8 is a perspective view of a stationary cam and rotating cam positioned between two reaction plates.

FIG. 9 is a perspective view of the stationary cam of the present invention.

FIG. 10 is a partial cross sectional view of the stationary cam of the present invention.

FIG. 10A is an enlarged partial cross sectional view of the stationary cam of FIG. 10.

FIG. 11 is a partial cross sectional view of the centrifugal clutch in a direction facing the vehicle engine.

FIG. 12 is a perspective view of an adjustment member according to a preferred embodiment of the present invention shown disengaged from the rotating cam.

FIG. 13 is a front and side elevational view of a resiliently compressible member disposed between a reaction plate and the adjustment member of FIG. 12.

FIG. 14 is a perspective view of an adjustment member according to a second embodiment of the present invention.

FIG. 15 is a cross sectional view of the clutch of the present invention in the disengaged position exhibiting no wear.

FIG. 16 is a cross sectional view of the clutch of the present invention in the engaged position exhibiting no wear.

FIG. 17 is a cross sectional view of the clutch of the present invention in the disengaged position exhibiting wear.

FIG. 18 is a cross sectional view of the clutch of the present invention in the disengaged position after a wear compensating adjustment.

FIG. 19 is a chart illustrating the operational adjustment positions of the clutch of the present invention.

### DESCRIPTION OF THE PREFERRED EMBODIMENT

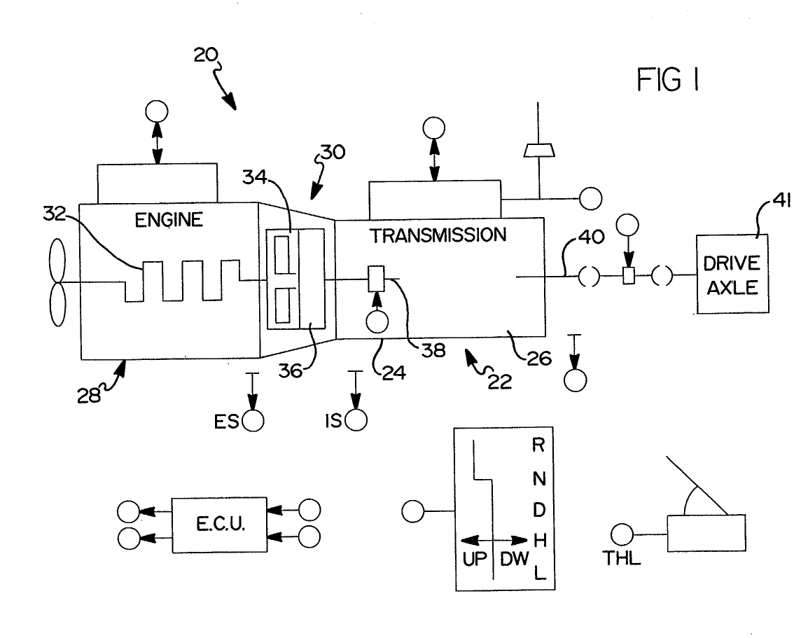

Referring now to the drawings, the preferred embodiments of the present invention are described in detail. An at least partially automated vehicle drive-train system 20 utilizing the centrifugally operated master friction clutch of the present invention is schematically illustrated in FIG. 1. System 20 may be fully automated, as seen by way of example in U.S. Pat. No.: 4,361,060, partially automated, as seen by way of example in U.S. Pat. Nos.: 4,648,290 and 5,409,432, or manual with controller assist, as seen by way of example in U.S. Pat. Nos.: 4,850,236; 5,582,558; 5,735,771; and 6,015,366.

In system 20, a multi-gear transmission 22 comprising a main transmission section 24 connected in series with a splitter-type auxiliary transmission section 26 is drivingly connected to an internal combustion engine 28, such as a gasoline or diesel engine, by a centrifugal master friction clutch 30 of the present invention. Transmission 22, by way of example, may be of the type well known in the prior art and sold by the assignee of this application, EATON CORPORATION, under the trademarks “Super-10” and “Lightning”, and may be seen in greater detail by reference to U.S. Pat. Nos.: 4,754,665; 6,015,366; 5,370,013; 5,974,906; and 5,974,354, the disclosures of which are incorporated herein by reference in their entirety.

Engine 28 includes a crankshaft 32, which is attached to an input member 34 of centrifugal master friction clutch 30. Input member 34 frictionally engages with, and disengages from, an output member 36, which is attached to an input shaft 38 of transmission 22. A transmission output shaft 40 extends from the auxiliary transmission section 26 for driving connection to the vehicle drive wheels through a drive axle 41 or transfer case.

The terms “engaged” and “disengaged” as used in connection with a master friction clutch refer to the capacity, or lack of capacity, respectively, of the clutch to transfer a significant amount of torque. Mere random contact of the friction surfaces, in the absence of at least a minimal clamping force, is not considered engagement.

As may be seen from FIG. 1, centrifugal clutch 30 requires no external clutch actuator and is operated as a function of the rotational speed (ES) of the engine. Centrifugal clutch 30 also requires no connections to operating linkages, command signal inputs, power electronics and/or fluid power conduits. While the most economical application of the present invention is with a dry friction clutch, the present invention is also compatible with wet clutch technology.

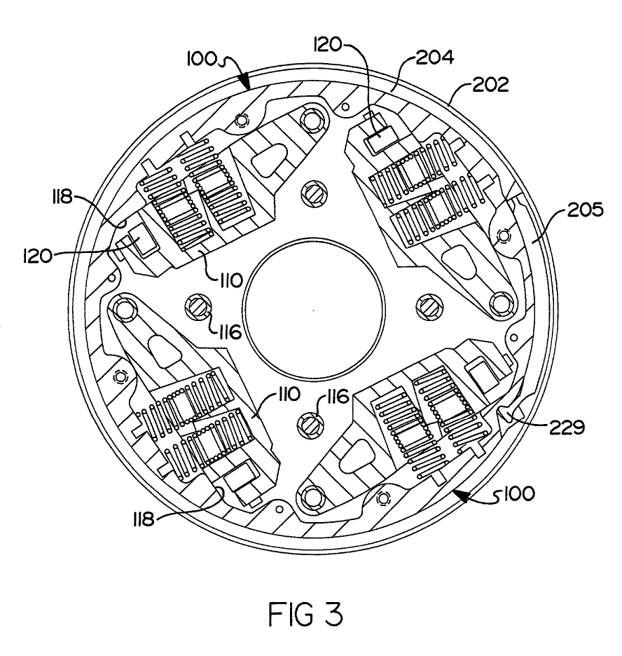

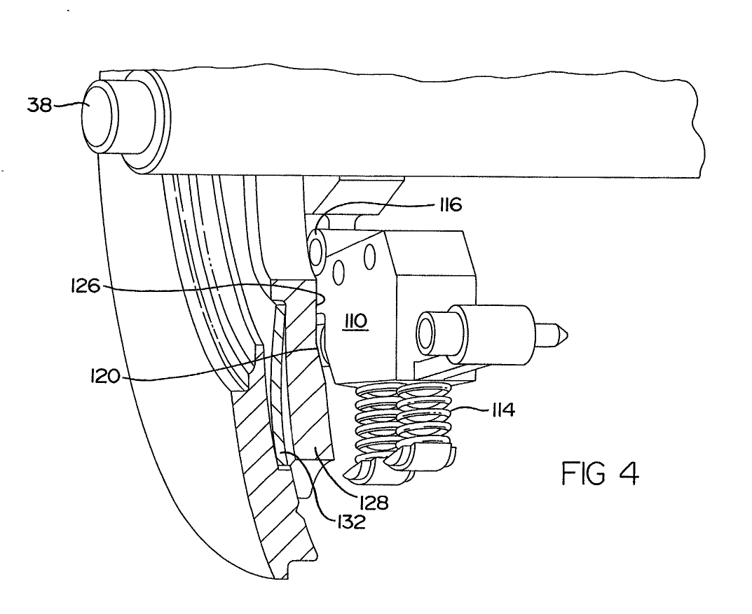

A more detailed view of the structure of centrifugal clutch 30 may be seen by reference to FIGS. 3-6. As is known, rotation of input portion 34 will cause clutch 30 to engage and drivingly connect an engine output member, usually an engine flywheel or the like, to transmission input shaft 38. The clamping force (CF) and torque transfer capacity of clutch 30 is a function of the rotational speed (ES) of engine 28 and clutch input member 34. Clutch 30 reaches incipient engagement at an engine speed (ES) greater than engine idle and fully engages at an engine speed lower than the engine speed at which a first upshift is required. Unlike normally closed master friction clutches that are normally engaged, clutch 20 is disengaged at lower engine speeds.

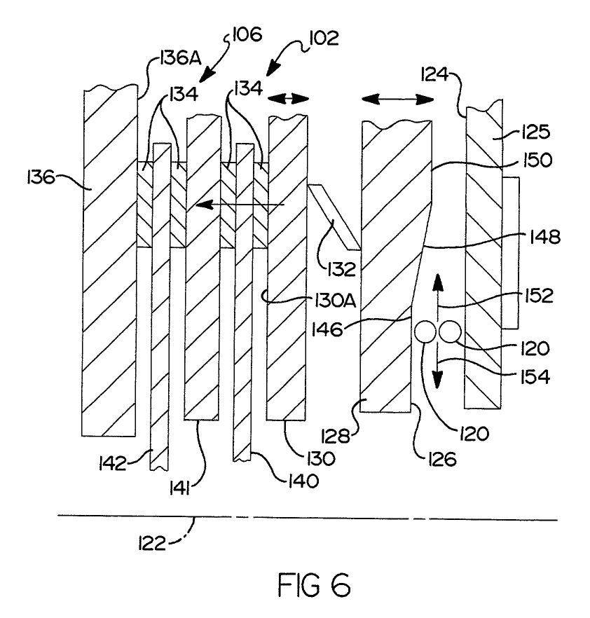

Referring to FIGS. 3 and 6 of the drawings, clutch 30 includes a clutch cover assembly 100, a first friction plate 102, an intermediate pressure plate 141, and a second friction plate 106. Cover assembly 100 and intermediate pressure plate 141 are mounted to the engine flywheel 136 via a cover or mounting bracket 101 for rotation therewith and comprise the input portion 34 of clutch 30. Friction plates 102 and 106 are typically splined to transmission input shaft 38 and comprise the output portion 36 of clutch 30.

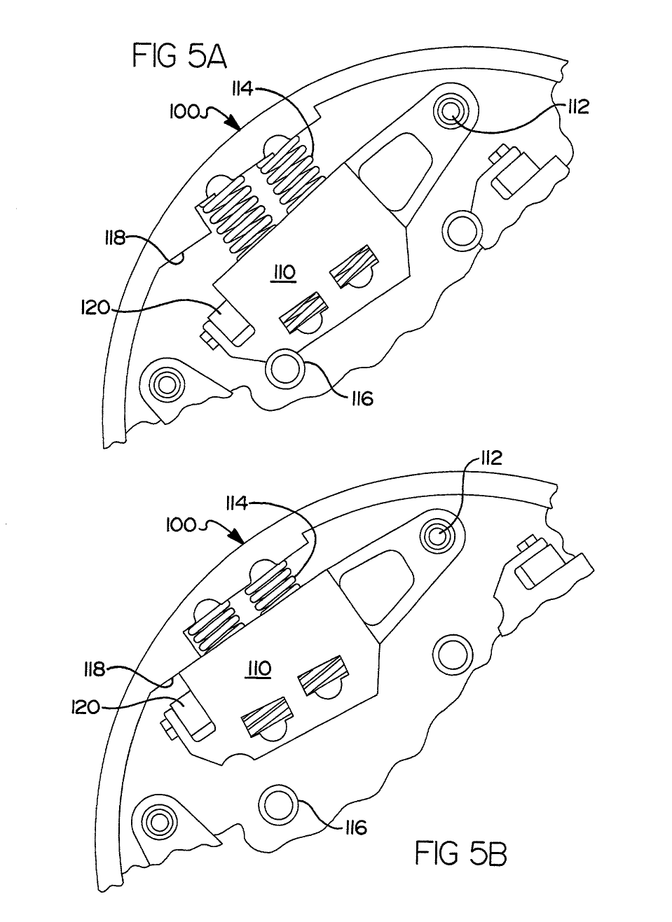

Referring to FIGS. 3-5B, cover assembly 100 includes four flyweights 110 that are pivotably mounted to cover assembly 100 at pivot pins 112. A plurality of return springs 114 bias the flyweights 110 radially inwardly to rest on stops 116 (see FIG. 5A). A surface 118 of cover assembly 100 limits the radially outward movement of flyweights 110 (see FIG. 5B). As engine 28 and cover assembly 100 rotate, the effect of centrifugal force will cause the flyweights 110 to move against the biasing force of springs 114 from the position of FIG. 5A to the position of FIG. 5B. Flyweights 110 each carry one or more rollers 120 or functionally similar wedging member, which act between a reaction surface and a ramp to provide an axial clamping force for engaging the master friction clutch 30.

FIG. 6 is a schematic illustration of the operational members shown in fragments as rotating about a rotational axis 122 of transmission input shaft 38. Rollers 120 of flyweights 110 are received between a substantially flat surface 124 of a fixed reaction plate 125 and a ramped surface 126 of an axially moveable ramp plate 128. The ramp plate 128 acts on an axially movable main pressure plate 130 through a preloaded spring member 132, such as a diaphragm spring, which limits the axial force applied to pressure plate 130 by ramp plate 128. Main pressure plate 130 will apply a clamping force (CF) on the friction pads 134 of friction plates 102, 106 which are trapped between surface 130A of the main pressure plate 130 and the intermediate pressure plate 141 and surface 136A of the engine flywheel 136. The hub portions 140 and 142 of the friction plates 102 and 106, respectively, are adapted to be splined to input shaft 38 for rotation therewith while plates 125, 128, 130, and 141 rotate with the engine flywheel 136.

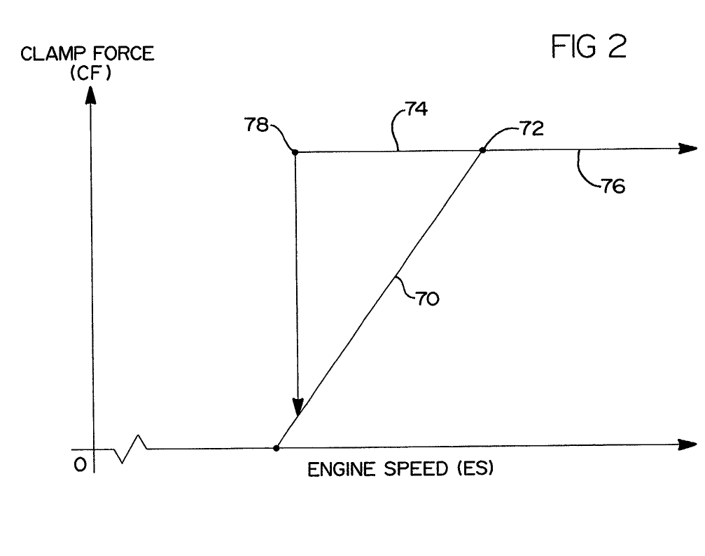

At rest, one of rollers 120 will engage the recessed portion 146 of surface 126 and will not apply a leftward acting axial clamping force (CF) to friction pads 134. As the roller 120 travels sufficiently radially outwardly and onto the ramped portion 148 of ramp surface 126, an increasing axial clamping force is applied (see line 70 of FIG. 2). As the roller moves further radially outwardly onto a substantially flat extended portion of 150 of ramp surface 126, the clamp force (CF) will remain at a capped value (see lines 74 and 76 of FIG. 2) as limited by spring member 132.

A greater centrifugal force 152 is required to move rollers 120 up ramp portion 148 to flat portion 150 than is required to retain the rollers on flat portion 150 against the effect of a radially inward directed spring force 154 generated by return springs 114. This accounts for the difference between the engine speed (ES) value at the initial maximum clamp force, point 72 of FIG. 2, and the release engine speed value, point 78 of FIG. 2. The relative masses of flyweights 110 and/or the spring rate of spring 114 may be modified to change the engine speed value at disengagement (point 78 of FIG. 2).

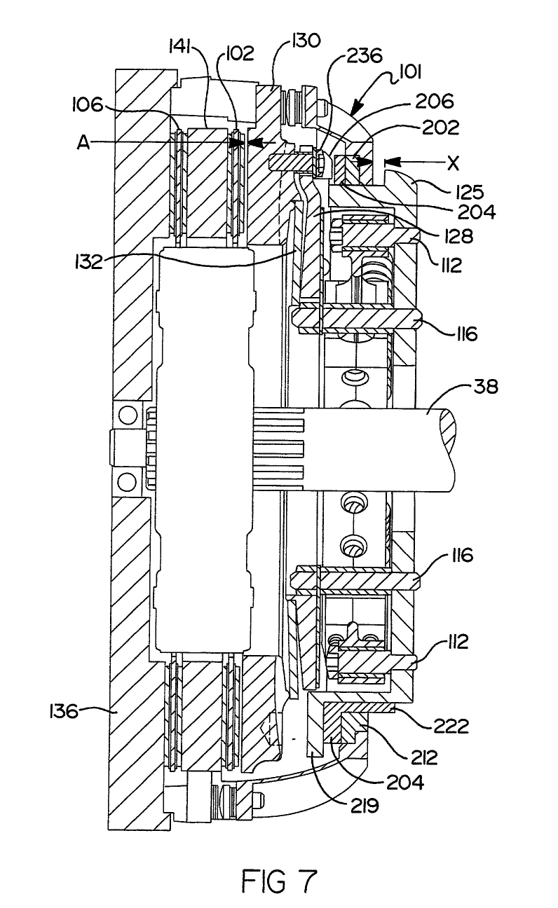

Referring to FIGS. 7-19 of the drawings, a centrifugal master friction clutch 30 employing the inventive wear compensation device will be described in detail. According to a preferred embodiment of the present invention, the wear compensation device comprises a stationary cam 202, a rotating cam 204, a resilient member 205 (FIG. 3) and at least one adjustment member 206 that cooperatively interact to compensate for wear in the frictional components of clutch 30. As shown in FIG. 7, stationary cam 202 and rotating cam 204 are disposed substantially between reaction plate 125 of cover assembly 100 and mounting bracket 101. A change in the axial dimension of the cooperating cams 202, 204 causes plate 125 to move in an axial direction relative to bracket 101 and toward friction plate 102 to compensate for wear in clutch 30.

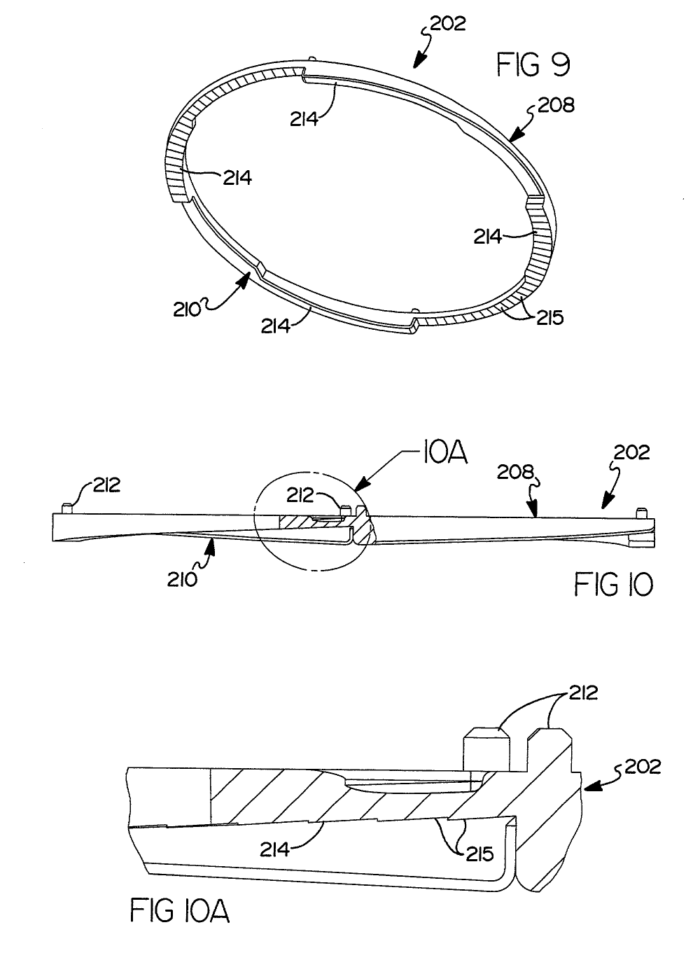

The terms “clockwise” and “counterclockwise”, as used herein, describe the relative rotation of rotating cam 204 as viewed, along with clutch 30, in a direction toward engine 28, as illustrated in FIG. 11.

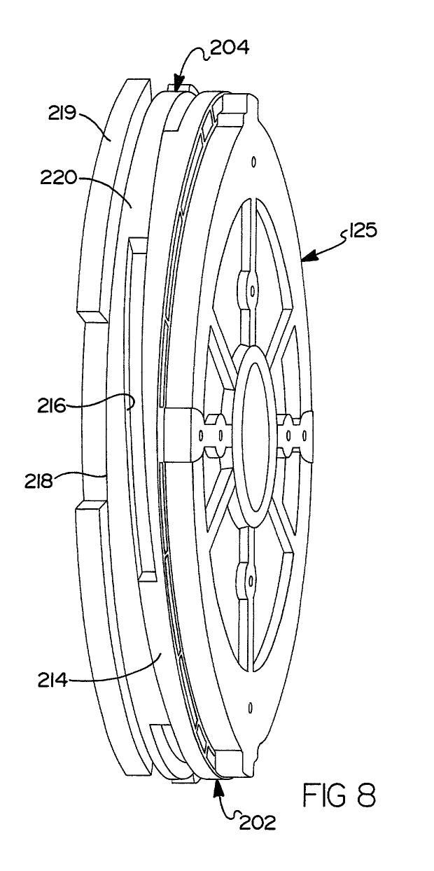

Referring to FIGS. 7-10A, a preferred embodiment of stationary cam 202 is shown in greater detail. Stationary cam 202 may be manufactured of a suitable metal, such as steel, or a composite material, such as graphite-reinforced plastic. In a preferred embodiment, stationary cam 202 exhibits a generally annular structure having a first side 208 facing mounting bracket 101 and a second side 210 facing rotating cam 204, as shown in FIG. 9. Referring to FIG. 10 of the drawings, first side 208 preferably includes a plurality of protrusions 212 that interlock with a a plurality of corresponding holes or grooves (not illustrated) in mounting bracket 101 to enable stationary cam 202 to rotate with cover assembly 100. Alternatively, installation cam 202 may be integrally formed with bracket 101.

As illustrated in FIGS. 8 and 9, second side 210 includes a plurality of inclined cam portions 214 disposed around the surface of second side 210. At least one, and more preferably two, cam portions 214 include a plurality of serrations 215 that create a series of steps on inclined cam portion 214 in an upward ramping direction. While in a preferred embodiment installation cam 202 is illustrated with four cam portions 214, it is recognized that the number of cam portions 214 may be greater or less than four, such as, for example, three or eight. As will be described in further detail below, cam portions 214 and serrations 215 are configured in size, shape and position to interact with rotating cam 204 in order to modify the cooperative axial length of mating cams 202 and 204.

Referring to FIGS. 7 and 8, a preferred embodiment of rotating cam 204 is shown in greater detail. Rotating cam 204 may be manufactured of a suitable metal, such as steel, or a composite material, such as graphite reinforced plastic. In a preferred embodiment, rotating cam 204 exhibits a generally annular structure having a first side 216 disposed adjacent stationary cam 202 and a second side 218 disposed opposite first side 216. As illustrated in the lower half of the drawing of FIG. 7, a portion of second side 218 abuts an integrally formed flange 219 that extends from reaction plate 125.

As illustrated in FIG. 8, first side 216 includes a plurality of inclined cam portions 220 that are substantially similar to cam portions 214 on stationary cam 202 with at least one exception, namely, cam portions 220 are positioned on rotating cam 204 such that the upward ramping direction of each cam portion 220 is opposite a downward ramping direction of cam portions 214. The alternating cam portions 214, 220 of stationary cam 202 and rotating cam 204, respectively, create an interface that permits rotation of rotating cam 204 during operation of clutch 30. The camming action created at the interface of stationary cam 202 and rotating cam 204 causes the cooperative axial length of mating cams 202, 204 to increase.

As is known in the art, sliding between two contacting bodies having angled mating surfaces can be limited by minimizing the relative angle of the mating surfaces. Accordingly, as illustrated in FIG. 8, the slope of cam portions 214, 220 is minimized to inhibit clockwise rotation of rotating cam 204. To further inhibit clockwise rotation of rotating cam 204, at least one, and more preferably two, cam portions 220 include a plurality serrations (not illustrated but substantially similar to serrations 215 shown in FIG. 9) that step upward in direction opposite serrations 215 on stationary cam 202. Serrations 215 on cam portion 214 interlock with the opposing serrations on cam portion 220 to prevent clockwise rotation of rotating cam 204. Alternatively, a frictional material may be applied to cam portions 214 and 220 instead of serrations 215 to prevent clockwise rotation of rotating cam 204.

Referring to FIGS. 7 and 11, rotating cam 204 further includes an integrally formed indicator member 222 that extends axially away from first side 216. Indicator member 222 is positioned radially inward of stationary cam 202 and rides in a groove 224 located in reaction plate 125. Indicator member 222 rotates with rotating cam 204 in groove 224 during a wear compensating adjustment. As illustrated in FIG. 11, indicator member 222 is used in conjunction with a visual cue 226 on a surface of clutch 30 to provide a visual indication of the level of wear in friction plates 102 and 106. A similar structure is shown in U.S. Pat. No. 5,531,308, owned by the Assignee of the present invention, the disclosure of which is hereby incorporated by reference in its entirety.

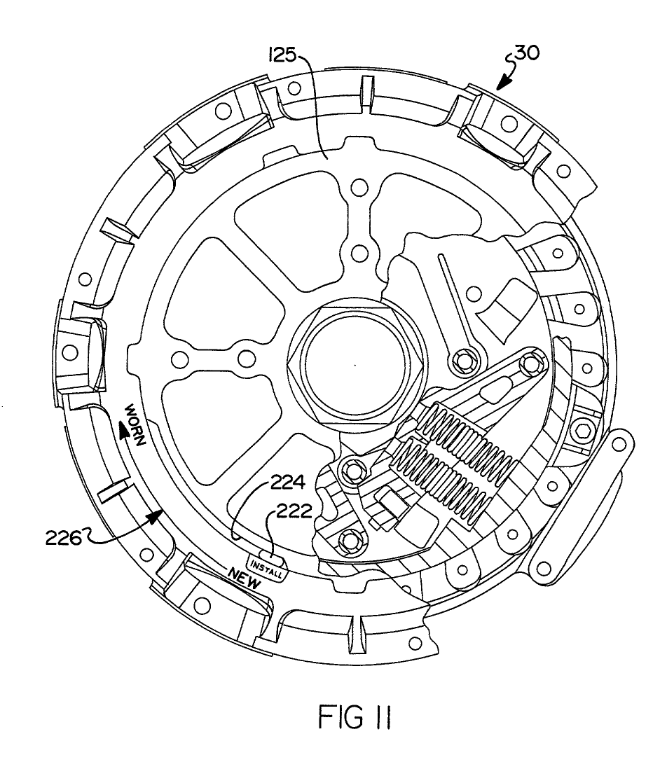

Referring to FIG. 12, at least a portion of second side 218 includes a plurality of teeth 228 designed to interact with adjustment member 206 to limit the degree of rotation of rotating cam 204. Teeth 228 are imbedded in rotating member 204 along an approximately 60 degree section of second side 218, such that the outer tip of teeth 228 are substantially flush with second side 218. However, the arc length of the portion of second side 218 that includes teeth 228 may be substantially more or less than 60 degrees depending on the number of cam portions used in stationary cam 202 and rotating cam 204. A portion of flange 219 is removed in the area adjacent the section of second side 218 that includes teeth 228, as shown in the top half of FIG. 7, to permit adjustment member 206 to engage teeth 228.

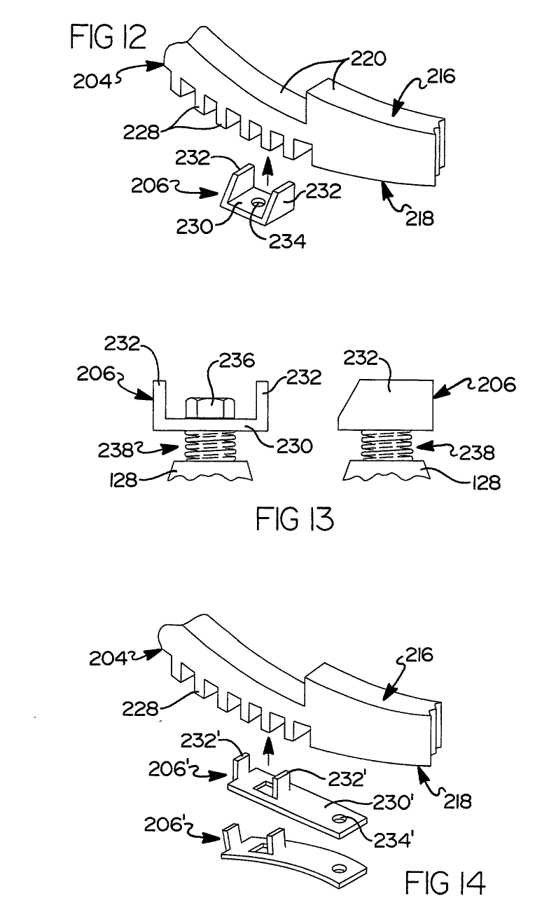

Referring to FIGS. 12 and 13 of the drawings, a preferred embodiment of adjustment member 206 is shown in detail. Adjustment member 206 comprises a substantially flat base portion 230 having at least one, and more preferably two, integrally formed arm members 232 that extend outwardly therefrom. Base portion 230 includes an aperture 234 therethrough for allowing passage of a fastener 236 used to secure adjustment member 206 to reaction plate 128. Once installed in clutch 30, adjustment member 206 is positioned such that arm members 232 are aligned with the section of rotating cam 204 that includes teeth 228, as shown in FIG. 7. The spacing between arm members 232 is configured to allow an individual tooth 228 on rotating cam 204 to be received therebetween without substantial interference. As will be described in further detail below, the inventive adjustment member 206 reduces the possibility of over-adjusting or under-adjusting clutch 30.

Referring to FIG. 13, a resiliently compressible member 238, such as a compression spring, may be disposed between adjustment member 206 and reaction plate 128 permitting adjustment member 206 to “float” between reaction plate 128 and rotating cam 204. Allowing adjustment member 206 to “float” prevents damage to the clutch components in the event arm members 232 and teeth 228 fail to intermesh, i.e. arm members 232 and the outer tip of teeth 228 co-align and abut.

Referring to FIG. 14, an adjustment member 206′ according to a second embodiment of the present invention is shown in detail. Adjustment member 206′ comprises a substantially rectangular strip of a resilient material, such as spring steel, that includes two integrally formed arm members 232′ that extend from a substantially flat base portion 230′. Base portion 230′ further includes an aperture 234′ therethrough to allow passage of fastener 236. As shown in FIG. 14, the resiliency of adjustment member 206′ enables it to deflect away from teeth 228 on rotating cam 204 in the event arm members 232′ fail to intermesh with teeth 228 as described above.

Referring again to FIG. 3, a preferred embodiment of resilient member 205 is shown in detail. Resilient member 205 is a circumferentially acting tension member, such as an index spring, that is disposed between cover assembly 100 and rotating cam 204. Each end of resilient member 205 includes a rigid head portion 240 that engages a corresponding receptacle on cover assembly 100 and rotating cam 204. Resilient member 205 is pre-tensioned in an initially installed position to provide a circumferentially acting biasing force against rotating cam 204. Alternatively, resilient member 205 may comprise a pre-loaded torsion spring (not illustrated) disposed between cover assembly 100 and rotating cam 204 that provides a rotational biasing force against rotating cam 204. As will be described in further detail below, the biasing force of resilient member 205 causes rotation of rotating cam 204 relative to cover assembly 100 and stationary cam 204 in the absence of an axial force acting against rotating cam 204.

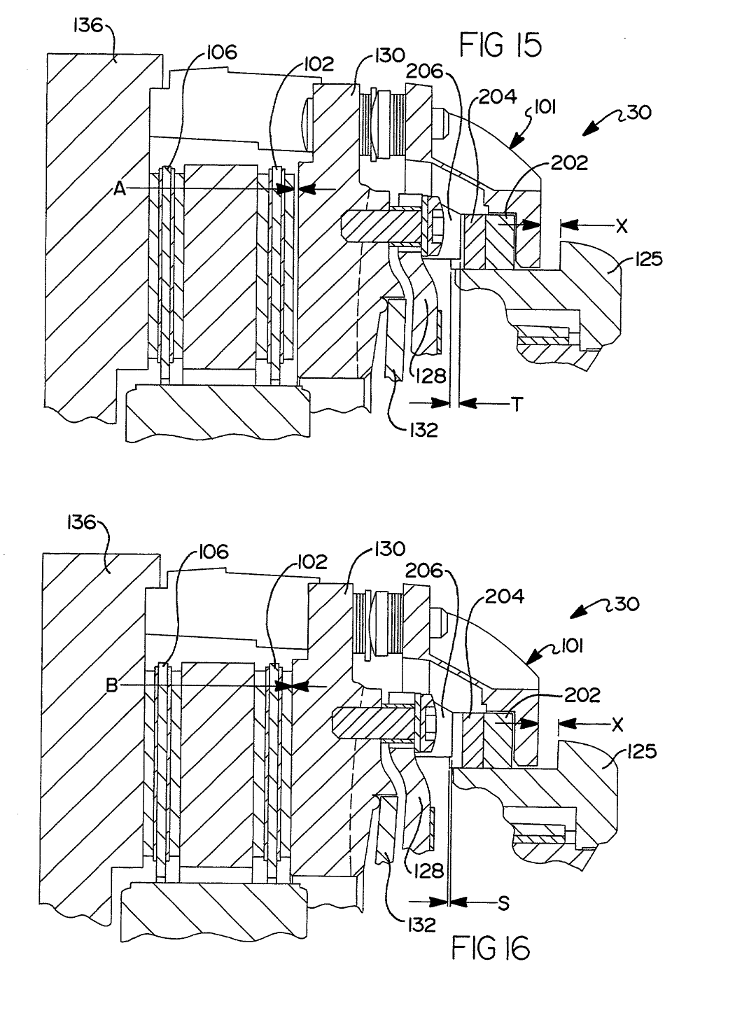

Operation of a centrifugal master friction clutch employing the inventive wear compensation device will be described with reference to FIGS. 15-19. Referring to FIG. 15, clutch 30 is shown in a disengaged position with no wear present in friction plates 102 and 106. In this position, engine 28 is typically idling, flyweights 110 are at rest against stops 116 and rollers 120 are received between flat surface 124 of fixed reaction plate 125 and ramped surface 126 of reaction plate 128. The distance pressure plate 130 must travel to engage friction plate 102, denoted as “A” in FIG. 15, is generally on the order of approximately 0.100 in (2.54 mm). However, other distances besides 0.100 in (2.54 mm) may be used provided cam portions 214 and 220 are sized accordingly. When clutch 30 is disengaged, arm members 232 of adjustment member 206 intermesh with teeth 225 of rotating cam 204 to prevent rotation of rotating cam 204 relative to stationary cam 202.

Referring to FIG. 16, clutch 30 is shown during engagement with no wear present in friction plates 102 and 106. As engine 28 and cover assembly 100 rotate, the effect of centrifugal force will cause flyweights 110 to move against the biasing force of springs 114 from the position shown in FIG. 5A to the position shown in FIG. 5B. As rollers 120 travel sufficiently radially outwardly and onto ramped portion 146 of ramped surface 126, an increasing axial clamping force (CF) is applied to friction plates 102, 106 (see FIG. 2). At a point where clutch 30 locks up (fully engaged), the centrifugal components of clutch 30 generate a return load against reaction plate 125 substantially equal the clamping force (CF) applied by pressure plate 130 against friction plate 102, but oppositely directed. The return load is transmitted axially through flange 219 of reaction plate 125 against rotating cam 204. Additionally, when engaged, arm members 232 of adjustment member 206 remain intermeshed with teeth 228 of rotating cam 204. However, the intermeshing length between adjustment member 206 and teeth 228 during engagement, denoted as “S” in FIG. 16 is less than the intermeshing length during disengagement, denoted as “T” in FIG. 15. The resulting return load against rotating cam 204 and the intermeshing of arm members 232 and teeth 228 prevent rotation of rotating cam 204 relative to stationary cam 202.

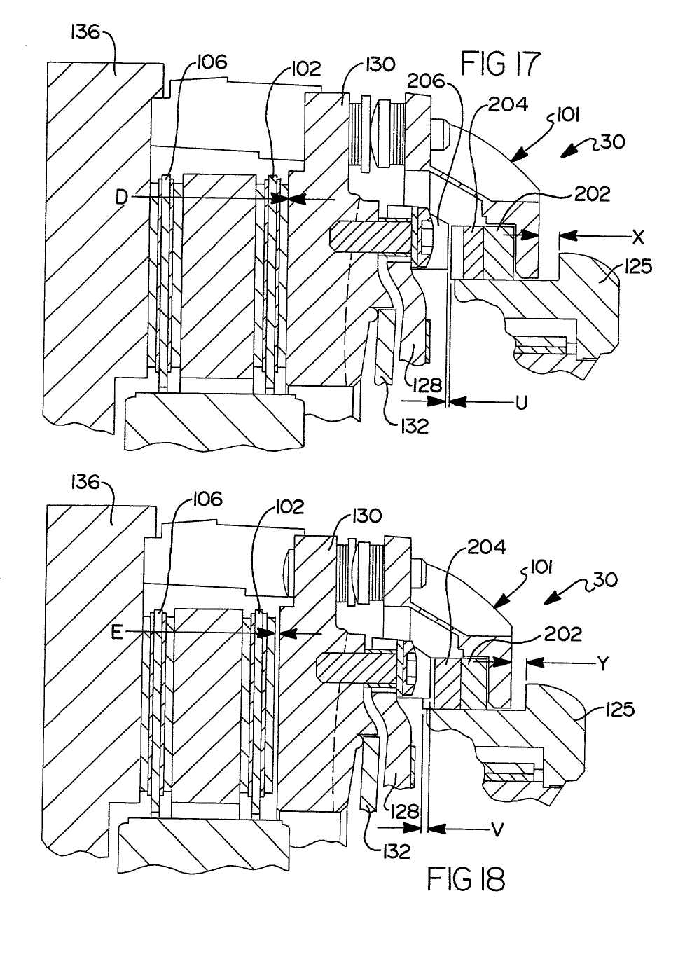

Referring to FIG. 17, clutch 30 is shown during engagement with wear present in friction plates 102 and 106. When wear is present in clutch 30, pressure plate 130 will travel an axial distance greater than approximately 0.100 in (2.54 mm) in order to provide a clamping force (CF) substantially equivalent to the clamping force applied when no wear is present in clutch 30. This additional displacement provides an opportunity for the inventive wear compensation device to make an adjustment in clutch 30 because arm members 232 are not intermeshed with teeth 228 of rotating cam 204, as denoted by the separation distance “U” in FIG. 17.

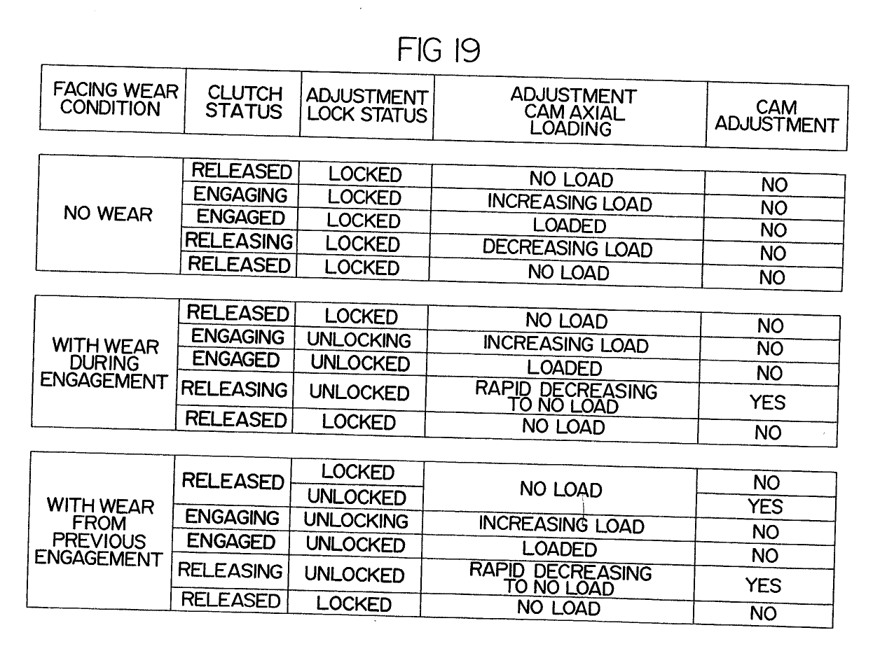

Referring to FIG. 19, a wear compensating adjustment may take place when two conditions are simultaneously present: (i) arm members 232 are not intermeshed (locked) with teeth 228; and (ii) no clamping force (CF) is being applied against friction plates 102, 106 or the clamping force (CF) is rapidly decreasing. If both conditions are present, the circumferentially acting biasing force of resilient member 205 causes rotating cam 204 to rotate relative to stationary cam 202, forcing each cam portion 220 on rotating cam 204 to travel up each corresponding cam portion 214 on stationary cam 202. As discussed above, the camming action created at the interface of stationary cam 202 and rotating cam 204 causes the cooperative axial length of cams 202, 204 to increase. The increased axial length of the cooperating cams 202, 204 forces reaction plate 125, and the remainder of cover assembly 100, to move in an axial direction toward friction plate 102. Accordingly, the amount of wear compensation provided by the wear compensation device is the difference between the original offset of reaction plate 125 from mounting bracket 101, denoted as a distance X in FIGS. 15-17, and the post-adjustment offset of reaction plate 125 from mounting bracket 101, denoted as a distance Y in FIG. 18.

The cooperating wear compensation components complete an adjustment when rotating cam 204 rotates to a point that either arm members 232 and teeth 228 intermesh or at a point where pressure plate 130 provides a clamping force (CF) against friction plate 102. If a wear compensating adjustment is made and arm members 232 fail to intermesh with teeth 228, the return load of pressure plate 130 will cause resiliently compressible member 238 to compress. Once clutch 30 is disengaged, i.e. the clamping force (CF) is removed or rapidly decreasing, rotating cam 204 is free to rotate until arm members 232 and teeth 228 to intermesh, as denoted by distance “V” in FIG. 18.

Although the inventive wear compensation device is particularly suited for use in a normally open (disengaged) friction clutch, such as a centrifugally operated friction clutch, it is recognized that the inventive wear compensation device may be used in other friction clutches, such as a normally closed (engaged) master friction clutch.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

What is claimed is:

1. A centrifugal friction clutch comprising an input portion fixed for rotation with an engine flywheel and an output portion fixed for rotation with a transmission input shaft, the output portion comprising at least one friction plate secured to the transmission input shaft for rotation therewith, the input portion comprising a cover assembly secured to the engine flywheel via a mounting bracket and a wear compensation device disposed within the cover assembly between the mounting bracket and a centrifugal mechanism, the cover assembly including a pressure plate for applying a clamping force against the friction plate responsive to a plurality of flyweights that rotate outward under the effects of centrifugal force to cause the pressure plate to exert a clamping force against the friction plate, the wear compensation device comprising:
first and second annular members that cooperatively exhibit an axial length that changes according to a displacement characteristic of the pressure plate in relation to the friction plate as the friction plate wears from an initially installed condition to a worn condition;
the first annular member having a first side disposed adjacent the second annular member and a second side disposed opposite the first side;
at least a portion of the first side of the first annular member being in contact with at least a portion of the second annular member;
the contacting portions of the first and second annular members being configured to vary the axial length of the cooperating first and second annular members upon rotation of the first annular member relative to the second annular member to modify the position of the cover assembly relative to the friction plate; and
a resilient member disposed between the first annular member and the cover assembly that causes the first annular member to rotate relative to the second annular member in the absence of an axial force on the first annular member.

2. The clutch according to claim 1, wherein the resilient member is an index spring.

3. The clutch according to claim 2, wherein the resilient member is pre-tensioned in the initially installed position.

4. The clutch according to claim 2, wherein the resilient member is circumferentially disposed between the first annular member and the cover assembly.

5. The clutch according to claim 1, wherein the resilient member is a torsion spring.

6. The clutch according to claim 1, wherein the second annular member is fixed to the mounting bracket.

7. The clutch according to claim 1, wherein the contacting portions of the first and second annular members comprise a plurality of inclined cam portions.

8. The clutch according to claim 7, wherein an upward ramping direction of each cam portion of the first annular member is opposite an upward ramping direction of each cam portion of the second annular member.

9. The clutch according to claim 7, wherein a mating surface of at least one of the cam portions of the first and second annular members includes a plurality of serrations.

10. The clutch according to claim 9, wherein the serrations create a series of steps on the mating surface of each cam portion in an upward ramping direction.

11. The clutch according to claim 9, wherein the serrations on the cam portion of the first annular member interlock with the serrations on the cam portion of the second annular member to prevent rotation of the first annular member relative to the second annular member in one direction.

12. The clutch according to claim 7, wherein a mating surface at least one of the cam portions on the first annular member and an opposing cam portion on the second annular member each include a frictional material to prevent rotation of the first annular member relative to the second annular member in one direction.

13. The clutch according to claim 1, wherein the first annular member includes an integrally formed indicator member that extends axially away from the first side.

14. The clutch according to claim 13, wherein the indicator member is used in conjunction with a visual cue on a surface of the friction clutch to visually indicate the level of wear in the friction clutch.

15. The clutch according to claim 1 further including an adjustment member comprising a substantially flat base portion having at least one integrally formed arm member that extends outwardly therefrom to engage the first annular member to limit the rotation of the first annular member relative to the second annular member.

16. The clutch according to claim 15, wherein the base portion includes an aperture therethrough for allowing passage of a fastener that secures the adjustment member to the cover assembly.

17. The clutch according to claim 15, wherein the adjustment member is biased by a resiliently compressible member.

18. The clutch according to claim 15, wherein a portion of the second side of the first annular member includes a plurality of teeth, that align with and are engaged by the arm members of the adjustment member.

19. The clutch according to claim 15, wherein the teeth are imbedded in the first annular member such that an outer tip of the teeth are substantially flush with the second side.

20. The clutch according to claim 1 further including an adjustment member comprising a substantially rectangular strip of a resilient material having at least one integrally formed arm member that extends from a substantially flat base, the adjustment member positioned to engage the first annular member to limit the rotation of the first annular member relative to the second annular member.

21. A friction clutch comprising an input portion fixed for rotation with an engine flywheel and an output portion fixed for rotation with a transmission input shaft, the output portion comprising a friction plate secured to the transmission input shaft for rotation therewith, the input portion comprising a cover assembly secured to the engine flywheel via a mounting bracket and a wear compensation device disposed substantially between a reaction plate and the mounting bracket, the cover assembly including a pressure plate for applying a clamping force against the friction plate, the wear compensation device comprising:
first and second annular members that cooperatively exhibit an axial length that changes according to a displacement characteristic of the pressure plate in relation to the friction plate as the friction plate wears from an initially installed condition to a worn condition;
the first annular member having a first side disposed adjacent the second annular member and a second side disposed opposite the first side;
at least a portion of the first side of the first annular member being in contact with at least a portion of the second annular member and at least a portion of the second side of the first annular member including a plurality of teeth;
the contacting portions of the first and second annular members being configured to vary the axial length of the cooperating first and second annular members upon rotation of the first annular member relative to the second annular member to modify the position of the cover assembly relative to the friction plate;
a resilient member disposed between the first annular member and the cover assembly that causes the first annular member to rotate relative to the second annular member in the absence of an axial force on the first annular member; and
an adjustment member comprising a substantially flat base portion having at least one integrally formed arm member that extends outwardly therefrom, the adjustment member positioned to engage the teeth of the first annular member to limit the rotation of the first annular member relative to said second annular member.

22. A centrifugal friction clutch comprising an input portion fixed for rotation with an engine flywheel and an output portion fixed for rotation with a transmission input shaft, the output portion comprising at least one friction plate secured to the transmission input shaft for rotation therewith, the input portion comprising a cover assembly secured to the engine flywheel via a mounting bracket and a wear compensation device disposed within the cover assembly between the mounting bracket and a centrifugal mechanism, the cover assembly including a pressure plate for applying a clamping force against the friction plate responsive to a plurality of flyweights that rotate outward under the effects of centrifugal force to cause the pressure plate to exert a clamping force against the friction plate, the wear compensation device comprising:
first and second annular members that cooperatively exhibit an axial length that changes according to a displacement characteristic of the pressure plate in relation to the friction plate as the friction plate wears from an initially installed condition to a worn condition;
the first annular member having a first side disposed adjacent the second annular member and a second side disposed opposite the first side;
at least a portion of the first side of the first annular member being in contact with at least a portion of the second annular member;
the contacting portions of the first and second annular members being configured to vary the axial length of the cooperating first and second annular members upon rotation of the first annular member relative to the second annular member to modify the position of the cover assembly relative to the friction plate; and
a resilient member disposed between the first annular member and the cover assembly that causes the first annular member to rotate relative to the second annular member in the absence of an axial force on the first annular member.
